(19) United States
(12) Patent Application Publication
(10) Pub. No.: US 2022/0164875 A1
(43) Pub. Date: May 26, 2022

(54) FINANCIAL RISK MANAGEMENT SYSTEM

(71) Applicant: HUCORE CO., LTD., Seoul (KR)

(72) Inventor: Seung Tae LEE, Seoul (KR)

(21) Appl. No.: 17/439,180

(22) PCT Filed: Mar. 18, 2020
(86) PCT No.: PCT/KR2020/003667

§ 371 Date: Sep. 14, 2021

(30) Foreign Application Priority Data
Mar. 18, 2019 (KR) 10-2019-0030631

(51) Int. Cl. G06Q 40/02

(52) U.S. Cl. CPC G06Q 40/025

(57) ABSTRACT

Provided is a financial risk management system including a liquidity risk management module configured to calculate and manage an adequate liquidity through volatility analysis of past actual cashflow of an economic unit versus a past planned cashflow, an interest rate risk management module configured to detect the degree of exposure to interest rate risk from financial asset information and financial debt information of the economic unit and measure and manage an interest rate risk of the detected exposure which varies according to domestic and foreign market interest rate volatility, and a foreign exchange risk management module configured to detect the degree of exposure to foreign exchange risk from foreign-currency financial asset information, foreign-currency financial debt information, and international transaction information of the economic unit and measure and manage a foreign exchange risk of the detected exposure which varies according to domestic and foreign exchange rate volatility.

### TECHNICAL FIELD

This invention relates to a financial risk management system. More specifically, the invention relates to a financial risk management system which evaluates financial risks including liquidity risk, interest rate risk, and foreign exchange risk of various economic units including companies and individuals and provides assessment information corresponding to the evaluated risks to the economic units so that the economic units may effectively manage financial risks.

### BACKGROUND ART

With the advent of the global economic era, numerous events occur and affect management of institutions and companies and also financial affairs of individuals. Also, there are an increasing number of institutions, companies, and individuals who come to a financial crisis or go into bankruptcy due to domestic or foreign variables, such as financial crises, contraction in the real-estate business, and foreign-exchange crises.

Accordingly, in operation of institutions or companies and asset/debt management of individuals, it is necessary to establish or examine a financial plan in preparation for such future variables or possible risks.

Public institutions or private companies make financial risk management efforts to actively cope with changes in business environments and business circumstances.

In practice, however, conventional financial risk management methods provide management with only rough estimations using the program “Excel.” Accordingly, it is not possible either to calculate adequate liquidity for an institution, company, or individual or to provide a risk management method suitable for financial assets, financial debts, foreign-currency financial assets, and foreign-currency financial debts against changes in an external environment. Also, it is difficult to apply various variables and calculate the amount of money to respond to risk tolerance according to each financial risk level in consideration of changes in several situations.

### PRIOR ART DOCUMENT

### Patent Document

(Patent Document 1) Korean Patent Registration No. 10-1059106 (filed on 18, Aug. 2011, title: Financial Risk Management System)
(Patent Document 2) Korean Patent Application Publication No. 10-2013-0100857 (filed on 12, Sep. 2013, title: System for Providing Financial Risk Management Service in SaaS Environment)

### DISCLOSURE OF INVENTION

### Technical Problem

The technical object of the present invention is to provide a financial risk management system which evaluates financial risks including liquidity risk, interest rate risk, and foreign exchange risk of various economic units including companies and individuals and provides assessment information corresponding to the evaluated risks to the economic units so that the economic units may effectively manage financial risks.

### Technical Solution

To solve the technical problems, a financial risk management system according to the present invention includes a liquidity risk management module configured to calculate and manage an adequate liquidity through volatility analysis of past actual cashflow of an economic unit versus a past planned cashflow, an interest rate risk management module configured to detect a degree of exposure to interest rate risk from financial asset information and financial debt information of the economic unit and measure and manage an interest rate risk of the detected exposure which varies according to domestic and foreign market interest rate volatility, and a foreign exchange risk management module configured to detect a degree of exposure to foreign exchange risk from foreign-currency financial asset information, foreign-currency financial debt information, and international transaction information of the economic unit and measure and manage a foreign exchange risk of the detected exposure which varies according to domestic and foreign exchange rate volatility.

In the financial risk management system, the liquidity risk management module may include a net difference between actual net cashflow and planned net cashflow calculation unit configured to receive the past planned cashflow and the past actual cashflow of the economic unit and calculate past net difference between actual net cashflow and planned net cashflows which are differences between planned net cashflow (fund outflow−fund inflow) included in the past planned cashflow and actual net cashflow included in the past actual cashflow, a net difference between actual net cashflow and planned net cashflow volatility measuring unit configured to measure a volatility of the past net difference between actual net cashflow and planned net cashflow by calculating an average and a standard deviation of the past net difference between actual net cashflow and planned net cashflow according to a measurement time period, an adequate liquidity calculation unit configured to calculate an adequate liquidity classified by risk-measuring period and confidence level according to the volatility of the past net difference between actual net cashflow and planned net cashflow, and a liquidity risk analysis unit configured to analyze liquidity risk by comparing a difference between the adequate liquidity and a currently held amount of cash and cash equivalents with a separately set liquidity risk tolerance.

In the financial risk management system, the liquidity risk management module may further include a liquidity risk assessment information providing unit configured to provide liquidity crisis level assessment information classified by level according to a degree of liquidity risk analyzed by the liquidity risk analysis unit.

In the financial risk management system, the interest rate risk management module may include a remaining maturity calculation unit configured to receive the financial asset information and the financial debt information of the economic unit, extract remaining maturities of individual financial assets and individual financial debts constituting the financial asset information and the financial debt information, and calculate an average remaining maturity by adding each different maturity multiplied by amount of individual financial assets and amount of individual financial debts as weights which divide individual financial assets by sum of total amount of total individual financial assets and divide individual financial debts by total amount of individual financial debts, an exposure to interest rate risk calculation unit configured to calculate amounts of financial assets and financial debts exposed to interest rate risk by multiplying a maturity adjustment factor, in which the remaining maturities of the individual financial assets and financial debts are taken into consideration on the basis of a reference date, a risk exposure adjustment factor, in which an interest rate risk measuring period is taken into consideration, and an interest rate, a base interest rate information collection unit configured to collect base interest rate information, a base interest rate volatility calculation unit configured to analyze the base interest rate information collected by the base interest rate information collection unit and calculate a base interest rate volatility according to the interest rate risk measuring period and a confidence level, an interest rate risk calculation unit configured to calculate a financial asset interest rate risk by multiplying the amount of financial assets exposed to risk by the base interest rate volatility, calculate a financial debt interest rate risk by multiplying the amount of financial debts exposed to risk by the base interest rate volatility, and calculate an interest rate risk by offsetting the interest rate risk of financial asset against the interest rate risk of financial debt, and an interest rate risk analysis unit configured to analyze an interest rate risk by comparing the interest rate risk with a separately set interest rate risk tolerance.

In the financial risk management system, the interest rate risk management module may further include an interest rate risk assessment information providing unit configured to provide interest rate risk level assessment information classified by level according to a degree of interest rate risk analyzed by the interest rate risk analysis unit.

In the financial risk management system, the foreign exchange risk management module may include an exposure to foreign exchange risk calculation unit configured to calculate an amount of foreign-currency financial assets exposed to foreign exchange risk by adding individual foreign-currency financial assets constituting the foreign-currency financial asset information on the basis of the reference date, calculate an amount of foreign-currency financial debts exposed to foreign exchange risk by adding individual foreign-currency financial debts constituting the foreign-currency financial debt information on the basis of the reference date, and calculate an amount of exposed to international transaction risk by relating balances and remaining maturities of individual international transactions constituting the international transaction information to a risk measuring period on the basis of the reference date, a basic foreign exchange rate information collection unit configured to collect basic foreign exchange rate information, a basic foreign exchange rate volatility calculation unit configured to analyze the basic foreign exchange rate information collected by the basic foreign exchange rate information collection unit and calculate a basic foreign exchange rate volatility according to a foreign exchange risk measuring period and a confidence level, a foreign exchange risk calculation unit configured to calculate a foreign-currency financial asset foreign exchange risk by multiplying the amount of foreign-currency financial assets exposed to risk by the basic foreign exchange rate volatility, calculate a foreign-currency financial debt foreign exchange risk by multiplying the amount of foreign-currency financial debts exposed to risk by the basic foreign exchange rate volatility, calculate a foreign exchange risk of foreign-currency financial net assets by offsetting the foreign exchange risk of foreign currency financial asset against the foreign exchange risk of foreign currency financial debt, and calculate an international transaction risk by multiplying the amount of cash and cash equivalents exposed to international transaction risk by the basic foreign exchange rate volatility, and a foreign exchange risk analysis unit configured to analyze foreign exchange risk of a foreign currency net financial asset by comparing foreign exchange risk of a foreign currency net financial asset with a separately set foreign exchange risk tolerance and analyze a foreign exchange risk of international transaction by comparing the foreign exchange risk of international transaction with a separately set foreign exchange risk tolerance.

In the financial risk management system, the foreign exchange risk management module may further include a foreign exchange risk assessment information providing unit configured to provide foreign exchange risk level assessment of foreign currency net financial asset information classified by level according to a degree of foreign exchange risk of foreign currency net financial asset analyzed by the foreign exchange risk analysis unit and provide foreign exchange risk level assessment of international transaction information classified by level according to a degree of foreign exchange risk of international transaction analyzed by the foreign exchange risk analysis unit.

### Advantageous Effects of Invention

According to the present invention, a financial risk management system evaluates financial risks including liquidity risk, interest rate risk, and foreign exchange risk of various economic units including companies and individuals and provides assessment information corresponding to the evaluated risks to the economic units so that the economic units may effectively manage financial risks.

### BRIEF DESCRIPTION OF DRAWINGS

FIG. 1 is a diagram showing a financial risk management system according to an embodiment of the present invention.

FIG. 2 is a diagram illustrating overall operation of the financial risk management system according to an embodiment of the present invention.

FIG. 3 is a diagram illustrating a configuration of a liquidity risk management module included in the financial risk management system according to an embodiment of the present invention.

FIG. 4 is a diagram illustrating operation of the liquidity risk management module illustrated in FIG. 3.

FIG. 5 is a diagram illustrating a configuration of an interest rate risk management module included in the financial risk management system according to an embodiment of the present invention.

FIG. 6 is a diagram illustrating operation of the interest rate risk management module illustrated in FIG. 5.

FIG. 7 is a diagram illustrating a configuration of a foreign exchange risk management module included in the financial risk management system according to an embodiment of the present invention.

FIG. 8 is a diagram illustrating operation of the foreign exchange risk management module illustrated in FIG. 7.

### MODE FOR INVENTION

In embodiments according to the concept of the present invention disclosed in this specification, specific structural or functional descriptions are merely illustrated for the purpose of describing the embodiments according to the concept of the present invention. The embodiments according to the concept of the present invention may be implemented in various forms and are not limited to the embodiments described in this specification.

Since the embodiments according to the concept of the present invention may be modified in various ways and may have several forms, the embodiments will be shown in the drawings and described in detail in this specification. However, the embodiments are not intended to limit the embodiments according to the concept of the present invention to particular disclosed forms and include all changes, equivalents, or substitutes included in the spirit and technical scope of the present invention.

Although the terms, such as first and second, are used to describe various elements, the elements should be not be limited by the terms. The terms are used only to distinguish one element from other elements. For example, without departing from the scope according to the concept of the present invention, a first element may be termed a second element, and similarly, a second element may be termed a first element.

It is to be understood that when an element is referred to as being “connected” or “coupled” to another element, the element may be directly connected or coupled to the other element or an intermediate element may be present therebetween. On the other hand, it is to be understood that when an element is referred to as being “directly connected” or “directly coupled” to another element, there is no intermediate element therebetween. Other words used to describe the relationship between elements, that is, “between” and “directly between,” “adjacent” and “directly adjacent,” etc., should be interpreted in a like fashion.

Terminology used herein is for the purpose of describing particular embodiments only and is not intended to limit the present invention. The singular forms include the plural forms as well unless the context clearly indicates otherwise. It will be understood that the terms “include,” “have,” etc., when used herein, specify the presence of stated features, integers, steps, operations, elements, parts, or combinations thereof but do not preclude the presence or addition of one or more other features, integers, steps, operations, elements, parts, or combinations thereof.

Unless otherwise defined, all terms including technical and scientific terms used herein have the same meaning as commonly understood by those of ordinary skill in the art to which the present invention pertains. Terms, such as those defined in commonly-used dictionaries, should be interpreted as having a meaning which is consistent with their meaning in the context of the relevant art and will not be interpreted in an idealized or overly formal sense unless clearly so defined herein.

Hereinafter, exemplary embodiments of the present invention will be described in detail with reference to the accompanying drawings.

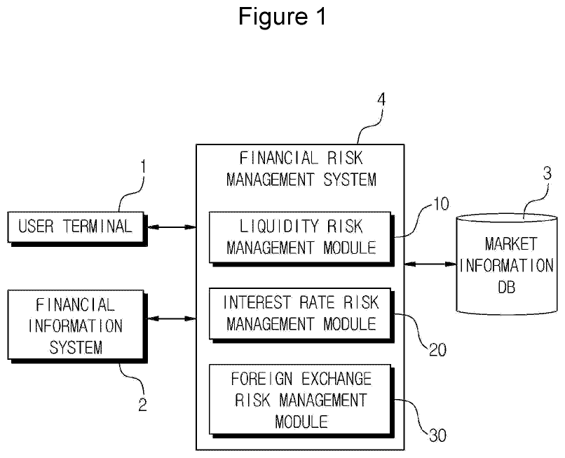

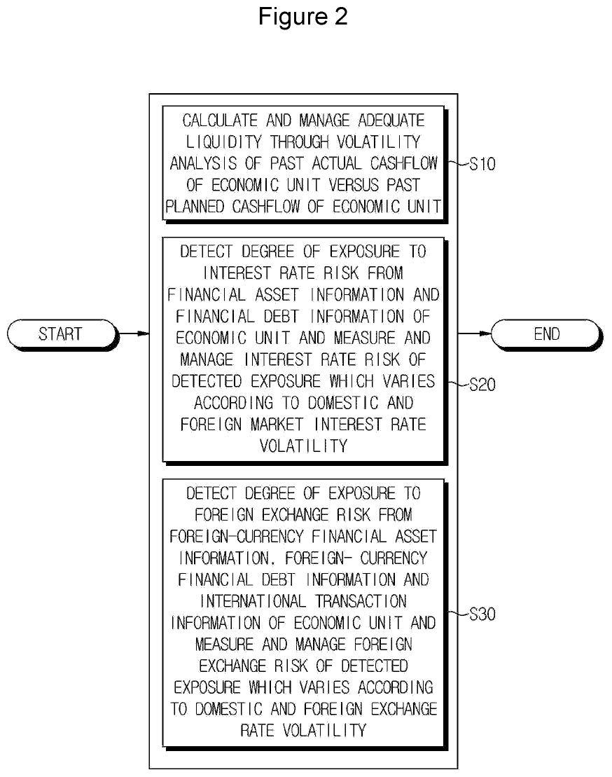

FIG. 1 is a diagram showing a financial risk management system according to an embodiment of the present invention, and FIG. 2 is a diagram illustrating overall operation of the financial risk management system according to an embodiment of the present invention.

Referring to FIGS. 1 and 2, a financial risk management system 4 according to an embodiment of the present invention includes a liquidity risk management module 10, an interest rate risk management module 20, and a foreign exchange risk management module 30.

The liquidity risk management module 10 functions to calculate and manage an adequate liquidity through volatility analysis of past actual cashflow of an economic unit versus a past planned cashflow (S10).

The interest rate risk management module 20 functions to detect the degree of exposure to interest rate risk from financial asset information and financial debt information of the economic unit and measure and manage the volatility of the detected exposure which varies according to domestic and foreign market interest rate volatility (S20).

The foreign exchange risk management module 30 functions to detect the degree of exposure to foreign exchange risk from foreign-currency financial asset information, foreign-currency financial debt information, and international transaction information of the economic unit and measure and manage the volatility of the detected exposure which varies according to domestic and foreign market interest rate volatility (S30).

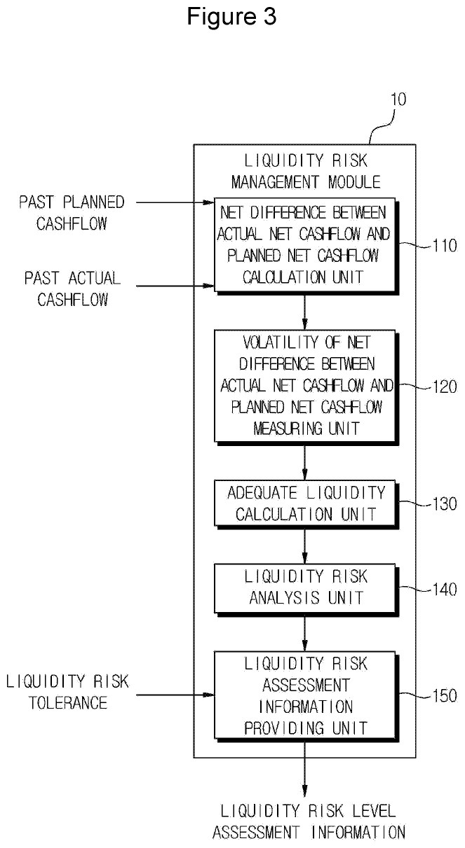

A detailed exemplary configuration of the financial risk management system 4 according to an embodiment of the present invention will be described below with additional reference to FIGS. 3 to 8.

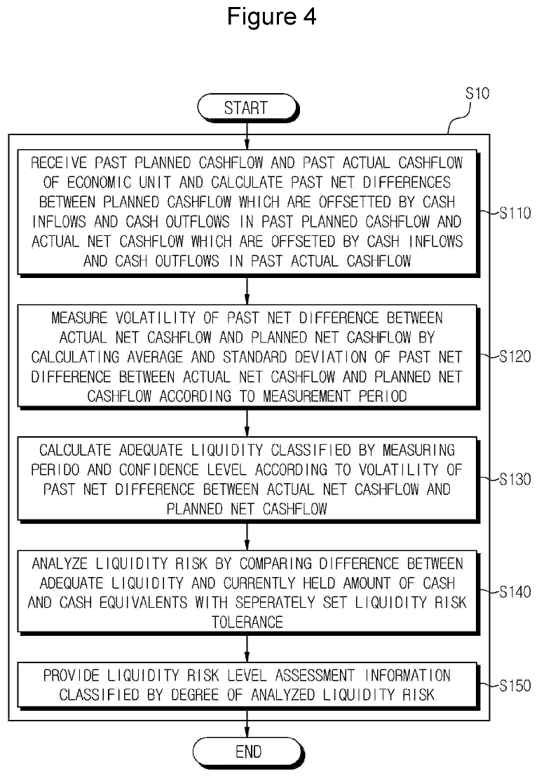

FIG. 3 is a diagram illustrating a configuration of the liquidity risk management module included in the financial risk management system according to an embodiment of the present invention, and FIG. 4 is a diagram illustrating operation of the liquidity risk management module illustrated in FIG. 3.

Referring to FIGS. 3 and 4, the liquidity risk management module 10 may be configured to include a net difference between actual net cashflow and planned net cashflow calculation unit 110, a volatility of net difference between actual net cashflow and planned net cashflow measuring unit 120, an adequate liquidity calculation unit 130, a liquidity risk analysis unit 140, and a liquidity risk assessment information providing unit 150.

The net difference between actual net cashflow and planned net cashflow calculation unit 110 functions to receive the past planned cashflow and the past actual cashflow of the economic unit and calculate past net differences between actual net cashflow and planned net cashflow which are differences between planned net cashflow included in the past planned cashflow and actual net cashflow included in the past actual cashflow (S110).

For example, the past planned cashflow and the past actual cashflow of the economic unit may be a planned and actual short-term fund balance which are classified by day, week, or month. When a financial information system 2 is provided in a company, the past planned cashflow and the past actual cashflow may be received from the financial information system 2. When the financial information system 2 is not provided, the past planned cashflow and the past actual cashflow of the economic unit may be received from an Excel file or directly input through a user terminal 1.

For example, a net cashflow and net differences between actual net cashflow and planned net cashflow may be calculated by Equation 1 below.

Net (Fund) Cashflow=(Fund) Cash outflows−(Fund) Cash inflows

Net differences between actual net cashflow and planned net cashflow=Planned Net Cashflow−Actual Net Cashflow [Equation 1]

The volatility of net difference between actual net cashflow and planned net cashflow measuring unit 120 functions to measure a volatility of the past net differences between actual net cashflow and planned net cashflow by calculating the average and the standard deviation of past net differences between actual net cashflow and planned net cashflow, which correspond to the past one, two, three years, or the like, calculated by the net difference between actual net cashflow and planned net cashflow calculation unit 110 (S120).

For example, the volatility of net difference between actual net cashflow and planned net cashflow may be calculated by Equation 2 below.

$${σ}_{t}^{2} = ( \frac{1}{n} ) \sum {( x - m )}^{2} \qquad [ Equation 2 ]$$

In Equation 2, m is the average of past net differences between actual net cashflow and planned net cashflow, and s is the standard deviation of the past net differences between actual net cashflow and planned net cashflow.

The adequate liquidity calculation unit 130 functions to calculate an adequate liquidity which is classified by measurement period and confidence level according to the volatility of past net differences between actual net cashflow and planned net cashflow measured by the volatility of net difference between actual net cashflow and planned net cashflow measuring unit 120 (S130).

For example, the measurement period of an adequate liquidity may be one, three, six, twelve months, or the like, and the confidence level thereof may be variously set to 90%, 95%, 99%, or the like.

For example, the adequate liquidity may be calculated by Equation 3 below.

Adequate liquidity=Cumulative Net Cashflow+σ(Standard Deviation)×Square Root of Measurement Period×Confidence Coefficient [Equation 3]

The liquidity risk analysis unit 140 functions to analyze liquidity risk by comparing a difference between the adequate liquidity calculated by the adequate liquidity calculation unit 130 and the amount of cash and cash equivalents that the economic unit currently has with a separately set liquidity risk tolerance (S140).

For example, the liquidity risk tolerance may be configured to be settable or resettable by a user.

The liquidity risk assessment information providing unit 150 functions to provide liquidity level assessment information which is classified by level according to the degree of liquidity risk analyzed by the liquidity risk analysis unit 140 (S150).

For example, liquidity level assessment information may be classified and provided as normal, notice, caution, and warning (danger), but a format in which liquidity crisis level assessment information is provided is not limited thereto.

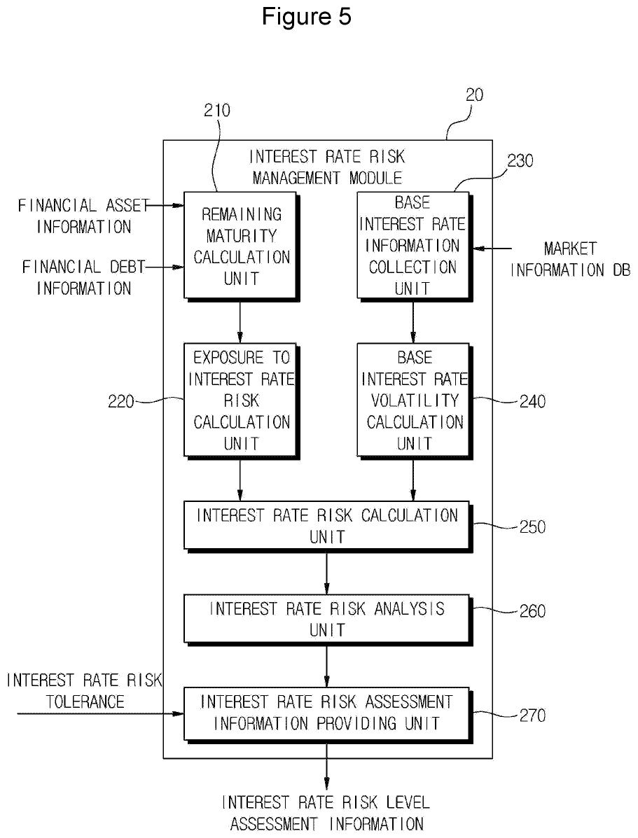

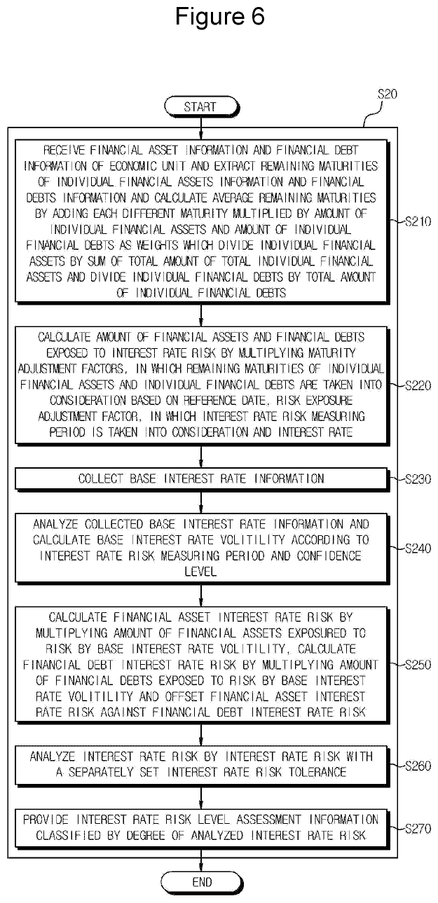

FIG. 5 is a diagram illustrating a configuration of the interest rate risk management module included in the financial risk management system according to an embodiment of the present invention, and FIG. 6 is a diagram illustrating operation of the interest rate risk management module illustrated in FIG. 5.

Referring to FIGS. 5 and 6, the interest rate risk management module 20 may be configured to include a remaining maturity calculation unit 210, an exposure to interest rate risk calculation unit 220, a base interest rate information collection unit 230, a base interest rate volatility calculation unit 240, an interest rate risk calculation unit 250, an interest rate risk analysis unit 260, and an interest rate risk assessment information providing unit 270.

The remaining maturity calculation unit 210 functions to receive the financial asset information and the financial debt information of the economic unit, extract remaining maturities of individual financial assets and individual financial debts constituting the financial asset information and the financial debt information, and calculate an average remaining maturity by adding each different maturity multiplied by amount of individual financial assets and amount of individual financial debts as weights which divide individual financial assets by sum of total amount of total individual financial assets and divide individual financial debts by total amount of individual financial debts (S210).

For example, the financial assets may be the amount of an ordinary deposit, a money market trust (MMT), a money market deposit account (MMDA), corporate bonds, government bonds, etc. and information related to interest returns and investment returns, and the financial debts may include loans and private loans and information on the issue dates, maturity dates, the amounts of money, interest rates, etc. of loans and private loans classified according to whether they are short-term or long-term and whether they are in a domestic currency or a foreign currency.

The exposure to interest rate risk calculation unit 220 functions to calculate the amounts of financial assets and financial debts exposed to risk by multiplying a maturity adjustment factor, in which the remaining maturities of the individual financial assets and financial debts are taken into consideration on the basis of a reference date, an exposure-to-risk adjustment factor, in which the risk measuring period is taken into consideration, and an interest rate (S220).

For example, the amount of financial assets exposed to interest rate risk may be calculated by Equation 4 below, and the amount of financial debts exposed to interest rate risk may be calculated by Equation 5 below.

Amount of Financial Assets Exposed to Interest rate risk=Σ(Amount of Individual Financial Asset on Reference Date×Maturity Adjustment Factor×Risk Exposure Adjustment Factor×Interest Rate) [Equation 4]

Amount of Financial Debt Exposed to Interest Rate Risk=Σ(Amount of Individual Financial Debt on Reference Date×Maturity Adjustment Factor×Risk Exposure Adjustment Factor×Interest Rate) [Equation 5]

The base interest rate information collection unit 230 functions to collect base interest rate information from a market information database (DB) 3 (S230).

For example, a base interest rate may include a daily interest rate, a 91-day certificate of deposit (CD) rate, a commercial paper (CP) rate, Korea Interbank Offered Rates (KORIBOR) (three, six, and twelve months), National Treasury bond (one/three/five/ten years), corporate bond rates (one and three years), etc. and may include daily, monthly, quarterly, and yearly closing prices or average interest rates.

The base interest rate volatility calculation unit 240 functions to analyze the base interest rate information collected by the base interest rate information collection unit 230 and calculate a base interest rate volatility according to an interest rate risk measuring period and a confidence level (S240).

For example, the base interest rate volatility calculation unit 240 may measure and calculate the volatility of a base interest rate for the past one year. The interest rate risk measuring period may be one, three, six, twelve months or the like. The confidence level may be 90%, 95%, 99% or the like, and various well-known simulation techniques, such as moving average approach, risk matrix approach, and Monte Carlo simulation, may be applied as volatility measurement models.

The interest rate risk calculation unit 250 functions to 1) calculate an interest rate risk of financial asset by multiplying the amount of financial assets exposed to risk calculated by the exposure to interest rate risk calculation unit 220 by the base interest rate volatility calculated by the base interest rate volatility calculation unit 240, 2) calculate an interest rate risk of financial asset by multiplying the amount of financial debts exposed to risk calculated by the exposure to interest rate risk calculation unit 220 by the base interest rate volatility, and 3) offset the interest rate risk of financial asset against the interest rate risk of financial debt (S250).

For example, the interest rate risk includes interest rate earnings at risk (EaR), interest rate value at risk (VaR), etc. and may be checked in various ways according to the types of financial assets and financial debts, volatility measuring models, risk measuring periods, and confidence levels.

The interest rate risk analysis unit 260 functions to analyze an interest rate risk by comparing the interest rate risk calculated by the interest rate risk calculation unit 250 with a set interest rate risk tolerance (S260).

For example, the interest rate risk tolerance may be set and reset by a user.

The interest rate risk assessment information providing unit 270 functions to provide interest rate risk level assessment information which is classified by level according to the degree of interest rate risk analyzed by the interest rate risk analysis unit 260 (S270).

For example, the interest rate risk level assessment of financial debt information and the interest rate risk level assessment of financial asset information may be classified and provided as normal, notice, caution, and warning (danger), but a format in which interest rate risk level assessment information is provided is not limited thereto.

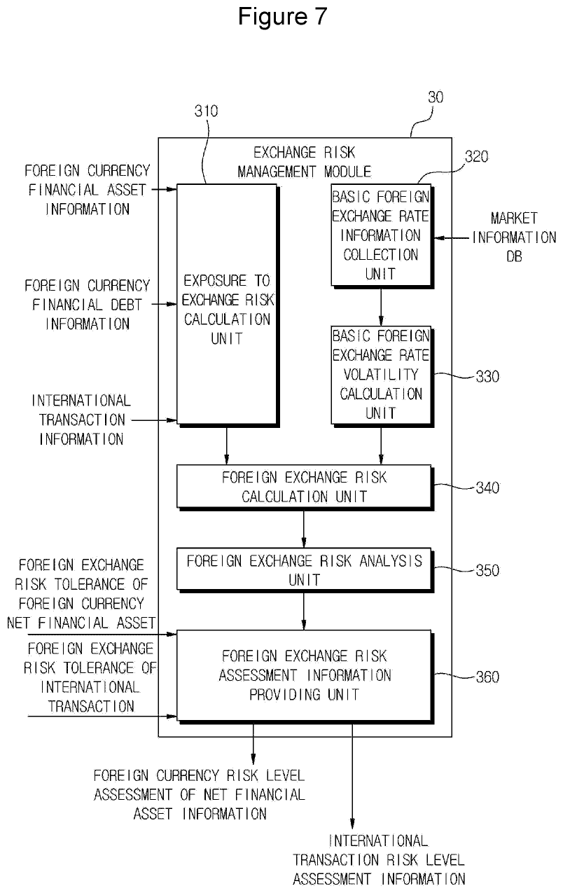

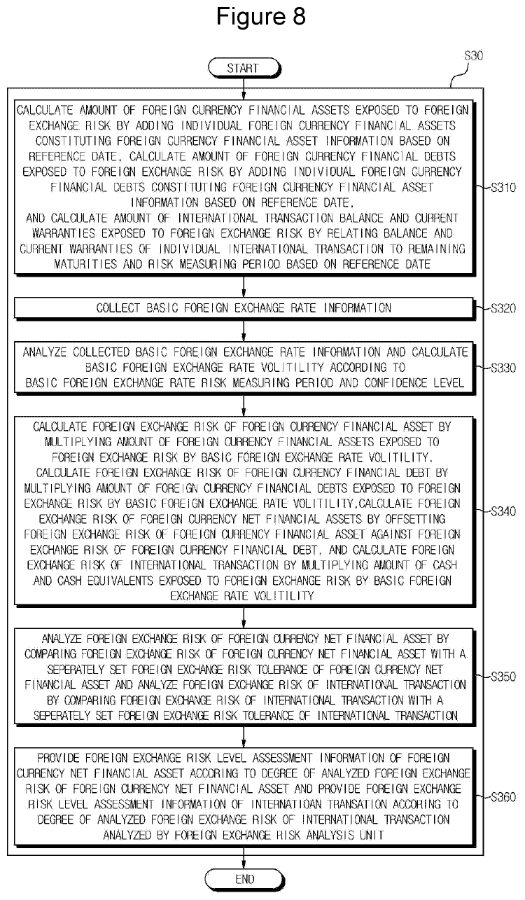

FIG. 7 is a diagram illustrating a configuration of the foreign exchange risk management module included in the financial risk management system according to an embodiment of the present invention, and FIG. 8 is a diagram illustrating operation of the foreign exchange risk management module illustrated in FIG. 7.

Referring to FIGS. 7 and 8, the foreign exchange risk management module 30 may include an exposure to foreign exchange risk calculation unit 310, a basic foreign exchange rate information collection unit 320, a basic foreign exchange rate volatility calculation unit 330, a foreign exchange risk calculation unit 340, a foreign exchange risk analysis unit 350, and a foreign exchange risk assessment information providing unit 360.

The exposure to foreign exchange risk calculation unit 310 functions to 1) calculate the amount of foreign-currency financial assets exposed to foreign exchange risk by adding individual foreign-currency financial assets constituting the foreign-currency financial asset information on the basis of the reference date, 2) calculate the amount of foreign-currency financial debts exposed to foreign exchange risk by adding individual foreign-currency financial debts constituting the foreign-currency financial debt information, and 3) calculate the amount of cash and cash equivalents exposed to international transaction risk by relating the balances and the remaining maturities of individual international transactions constituting the international transaction information to a risk measuring period on the basis of the reference date (S310).

For example, the foreign-currency financial asset information may include foreign currencies, foreign-currency deposits, foreign-currency stocks, the amount of foreign-currency bonds, and currency, and the foreign-currency financial debt information may include long-term and short-term foreign-currency loans and corporate bonds, each of which may include an issue date, a maturity date, the amount of money, a currency, and an interest rate. Also, the international transaction information may include the amount of cash and cash equivalents in international transactions, currencies, future rates, contract dates, and settlement dates.

For example, the amount of foreign-currency financial assets exposed to foreign exchange risk may be calculated by Equation 6 below, the amount of foreign-currency financial debts exposed to foreign exchange risk may be calculated by Equation 7 below, and the amount of cash and cash equivalents exposed to foreign exchange risk of international transaction may be calculated by Equation 8 below.

Amount of Foreign-Currency Financial Assets Exposed to foreign exchange risk=Σ(Amount of Individual Foreign-Currency Financial Asset on Reference Date) [Equation 6]

Amount of Foreign-Currency Financial Debts Exposed to foreign exchange risk=Σ(Amount of Individual Foreign-Currency Financial Debt on Reference Date) [Equation 7]

Amount of cash and cash equivalents exposed to foreign exchange risk of international transaction=Σ(Balance of Individual International Transaction on Reference Date) [Equation 8]

The basic foreign exchange rate information collection unit 320 functions to collect basic foreign exchange rate information from the market information DB 3 (S320).

For example, the basic foreign exchange rate information includes USD, EUR, JPY, etc. according to currency and may include information on daily, monthly, quarterly, and yearly closing rates or average exchange rates.

The basic foreign exchange rate volatility calculation unit 330 functions to analyze the basic foreign exchange rate information collected by the basic foreign exchange rate information collection unit 320 and calculate a basic foreign exchange rate volatility according to a foreign exchange risk measuring period and a confidence level (S330).

For example, the basic foreign exchange rate volatility calculation unit 330 may measure and calculate the volatility of a basic market exchange rate for the past one year. The foreign exchange risk measuring period may be one, three, six, twelve months or the like. The confidence level may be 90%, 95%, 99% or the like, and various well-known simulation techniques, such as moving average approach, risk matrix approach, and Monte Carlo simulation, may be applied as volatility measurement models.

The foreign exchange risk calculation unit 340 functions to 1) calculate a foreign exchange risk of foreign currency financial asset by multiplying the amount of foreign-currency financial assets exposed to foreign exchange risk calculated by the exposure to foreign exchange risk calculation unit 310 by the basic foreign exchange rate volatility calculated by the basic foreign exchange rate volatility calculation unit 330, 2) calculate a foreign exchange risk of foreign currency financial debt by multiplying the amount of foreign-currency financial debts exposed to foreign exchange risk calculated by the exposure to foreign exchange risk calculation unit 310 by the basic foreign exchange rate volatility, 3) calculate the foreign exchange risk of foreign-currency net financial asset by offsetting the foreign exchange risk of foreign currency financial asset against the foreign exchange risk of foreign currency financial debt, and 4) calculate the foreign exchange risk of international transaction by multiplying the amount of cash and cash equivalents exposed to foreign exchange risk of international transaction calculated by the exposure to foreign exchange risk calculation unit 310 by the basic foreign exchange rate volatility (S340).

For example, the foreign exchange risk includes foreign exchange EaR, foreign exchange VaR, etc. and may be checked in various ways according to currency-specific foreign-currency financial assets and foreign-currency financial debts, the types of import and export transactions, volatility measuring models, risk measuring periods, and confidence levels.

The foreign exchange risk analysis unit 350 functions to 1) analyze the foreign exchange risk of foreign currency net financial asset by comparing the foreign exchange risk of foreign currency net financial asset with a separately set the foreign exchange risk tolerance of foreign currency net financial asset and 2) analyze a foreign exchange risk of international transaction by comparing the international transaction risk calculated by the foreign exchange risk calculation unit 340 with a separately set foreign exchange risk tolerance of international transaction (S350).

For example, the foreign exchange risk tolerance of foreign currency net financial asset and the foreign exchange risk tolerance of international transaction may be set and reset by a user.

The foreign exchange risk assessment information providing unit 360 functions to 1) provide the foreign exchange risk tolerance of foreign currency net financial asset which is classified by level according to the degree of foreign exchange risk of foreign currency net financial asset analyzed by the foreign exchange risk analysis unit 350 and 2) provide foreign exchange risk level assessment of international transaction information classified by level according to the degree of international transaction risk analyzed by the foreign exchange risk analysis unit 350 (S360).

For example, the foreign exchange risk level assessment of foreign currency net financial asset information and the foreign exchange risk level assessment of international transaction information may be classified and provided as normal, notice, caution, and warning (danger), but a format in which the information is provided is not limited thereto.

According to the present invention, as described above in detail, a financial risk management system evaluates financial risks including liquidity risk, interest rate risk, and foreign exchange risk of various economic units including companies and individuals and provides assessment information corresponding to the evaluated risks to the economic units so that the economic units may effectively manage financial risks.

1. A financial risk management system comprising:
a liquidity risk management module configured to calculate and manage an adequate liquidity through volatility analysis of past actual cashflow of an economic unit versus a past planned cashflow;
an interest rate risk management module configured to detect a degree of exposure to interest rate risk from financial asset information and financial debt information of the economic unit and measure and manage an interest rate risk of the detected exposure which varies according to domestic and foreign market interest rate volatility; and
a foreign exchange risk management module configured to detect a degree of exposure to foreign exchange risk from foreign-currency financial asset information, foreign-currency financial debt information, and international transaction information of the economic unit and measure and manage a foreign exchange risk of the detected exposure which varies according to domestic and foreign exchange rate volatility,
wherein the liquidity risk management module comprises:
a net difference between actual net cashflow and planned net cashflow calculation unit configured to receive the past planned cashflow and the past actual cashflow of the economic unit and calculate past net differences between actual net cashflow and planned net cashflow which are differences between planned net cashflow included in the past planned cashflow and actual net cashflow included in the past actual cashflow;
a net difference between actual net cashflow and planned net cashflow volatility measuring unit configured to measure a volatility of the past net differences between actual net cashflow and planned net cashflow by calculating an average and a standard deviation of the past net differences between actual net cashflow and planned net cashflow according to a measurement time period;
an adequate liquidity calculation unit configured to calculate an adequate liquidity classified by measuring period and confidence level according to the volatility of the past net differences between actual net cashflow and planned net cashflow;
a liquidity risk analysis unit configured to analyze liquidity risk by comparing a difference between the adequate liquidity and a currently held amount of money with a set liquidity risk tolerance; and
a liquidity risk assessment information providing unit configured to provide liquidity level assessment information classified by level according to a degree of liquidity risk analyzed by the liquidity risk analysis unit,
wherein the interest rate risk management module comprises:
a remaining maturity calculation unit configured to receive the financial asset information and the financial debt information of the economic unit, extract remaining maturities of individual financial assets and individual financial debts constituting the financial asset information and the financial debt information, and calculate an average remaining maturity by adding each different maturity multiplied by amount of individual financial assets and amount of individual financial debts as weights which divide individual financial assets by sum of total amount of total individual financial assets and divide individual financial debts by total amount of individual financial debts;
an exposure to interest rate risk calculation unit configured to calculate amounts of financial assets and financial debts exposed to interest rate risk by multiplying a maturity adjustment factor, in which the remaining maturities of the individual financial assets and financial debts are taken into consideration on the basis of a reference date, a risk exposure adjustment factor, in which an interest rate risk measuring period is taken into consideration, and an interest rate;
a base interest rate information collection unit configured to collect base interest rate information;
a base interest rate volatility calculation unit configured to analyze the base interest rate information collected by the base interest rate information collection unit and calculate a base interest rate volatility according to the interest rate risk measuring period and a confidence level;
an interest rate risk calculation unit configured to calculate an interest rate risk of financial asset by multiplying the amount of financial assets exposed to interest rate risk by the base interest rate volatility, calculate an interest rate risk of financial debt by multiplying the amount of financial debts exposed to interest rate risk by the base interest rate volatility, and calculate an interest rate risk by offsetting the interest rate risk of financial asset against the interest rate risk of financial debt;
an interest rate risk analysis unit configured to analyze an interest rate risk by comparing the interest rate risk with a set interest rate risk tolerance; and
an interest rate risk assessment information providing unit configured to provide interest rate risk level assessment information classified by level according to a degree of interest rate risk analyzed by the interest rate risk analysis unit, and
wherein the foreign exchange risk management module comprises:
an exposure to foreign exchange risk calculation unit configured to calculate an amount of foreign-currency financial assets exposed to foreign exchange risk by adding individual foreign-currency financial assets constituting the foreign-currency financial asset information on the basis of the reference date, calculate an amount of foreign-currency financial debts exposed to foreign exchange risk by adding individual foreign-currency financial debts constituting the foreign-currency financial debt information on the basis of the reference date, and calculate an amount of cash and cash equivalents exposed to international transaction risk by relating balances and remaining maturities of individual international transactions constituting the international transaction information to a risk measuring period on the basis of the reference date;
a basic foreign exchange rate information collection unit configured to collect basic foreign exchange rate information;
a basic foreign exchange rate volatility calculation unit configured to analyze the basic foreign exchange rate information collected by the basic foreign exchange rate information collection unit and calculate a basic foreign exchange rate volatility according to a foreign exchange risk measuring period and a confidence level;
a foreign exchange risk calculation unit configured to calculate a foreign exchange risk of foreign currency financial asset by multiplying the amount of foreign-currency financial assets exposed to risk by the basic foreign exchange rate volatility, calculate a foreign exchange risk of foreign currency financial debt by multiplying the amount of foreign-currency financial debts exposed to risk by the basic foreign exchange rate volatility, calculate a foreign exchange risk of foreign-currency financial net assets by offsetting the foreign exchange risk of foreign currency financial asset against the foreign exchange risk of foreign currency financial debt, and calculate a foreign exchange risk of international transaction by multiplying the amount cash and cash equivalents exposed to foreign exchange risk of international transaction by the basic foreign exchange rate volatility;
a foreign exchange risk analysis unit configured to analyze foreign exchange risk of foreign currency net financial asset by comparing the foreign exchange risk of foreign currency net financial asset with a separately set foreign exchange risk of foreign currency net financial asset and analyze a foreign exchange risk of international transaction by comparing the foreign exchange risk of international transaction with a separately set foreign exchange risk of international transaction; and
a foreign exchange risk assessment information providing unit configured to provide foreign exchange risk level assessment of foreign currency net financial asset information classified by level according to a degree of foreign exchange risk of foreign currency net financial asset analyzed by the foreign exchange risk analysis unit and provide foreign exchange risk level assessment of international transaction information classified by level according to a degree of foreign exchange risk of international transaction analyzed by the foreign exchange risk analysis unit.
